(19) United States
(12) Patent Application Publication
(10) Pub. No.: US 2016/0223943 A1
(43) Pub. Date: Aug. 4, 2016

(54) DEVELOPER CONTAINER, IMAGE FORMING UNIT, AND IMAGE FORMING APPARATUS

(71) Applicant: Oki Data Corporation, Tokyo (JP)

(72) Inventor: Yoshihiro GOTO, Tokyo (JP)

(21) Appl. No.: 14/887,990

(22) Filed: Oct. 20, 2015

(30) Foreign Application Priority Data
Jan. 30, 2015 (JP) 2015-016476

(51) Int. Cl. G03G 15/08

(52) U.S. Cl. CPC G03G 15/0863

(57) ABSTRACT

A developer container according to the invention includes an indication formation portion for forming an identification indication. The developer container comprises an outline portion outlining a shape of the identification indication, the outline portion being formed projecting from a top surface of the indication formation portion, and a content region surrounded by the outline portion, the content region being formed recessing from a top of the outline portion toward a back side of the indication formation portion.

### CROSS REFERENCE TO RELATED APPLICATION

This application claims priority benefits under 35 USC, section 119 on the basis of Japanese Patent Application No. 2015-016476, the disclosure of which is incorporated herein by reference.

### BACKGROUND OF THE INVENTION

1. Field of the Invention

This invention relates to a developer container containing a developer such as, e.g., toner, an image forming unit having the developer container, and an image forming apparatus having the image forming unit.

2. Description of Related art

Developer units mounted on conventional image forming apparatuses are provided generally with an identification label printed with a logo on its top surface (see, generally Japanese Patent Application Publication No. 2000-338830). With the developer unit described above, however, the identification label may be peeled off, or foreign objects may be attached on the surface of the identification label, where the identification label printed with the logo on its top surface is adhered, and there raises a problem such that the logo becomes not easily recognizable.

### SUMMARY OF THE INVENTION

To solve the above problem, a developer container according to the invention has an indication formation portion for forming an identification indication. The developer container comprises: an outline portion outlining a shape of the identification indication, the outline portion being formed projecting from a top surface of the indication formation portion; and a content region surrounded by the outline portion, the content region being formed recessing from a top of the outline portion toward a back side of the indication formation portion.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic perspective view showing an appearance of a printer according to a first embodiment of the invention, when covers of the printer are opened;

FIG. 2 is a diagram showing the printer according to the first embodiment;

FIG. 3 is a schematic perspective view showing an appearance of a developer unit for the printer according to the first embodiment;

FIG. 4 is a perspective view showing a logo according to the first embodiment;

FIG. 5 is a cross section, showing the logo, taken along V-V line when viewed in the arrow direction in FIG. 4;

FIG. 6 is a perspective view showing a comparative example of the logo according to the first embodiment;

FIG. 7 is a perspective view showing another comparative example of the logo according to the first embodiment;

FIG. 8 is a perspective view showing a logo according to a second embodiment; and

FIG. 9 is a cross section, showing the logo, taken along IX-IX line when viewed in the arrow direction in FIG. 8.

### DETAILED DESCRIPTION OF EMBODIMENTS

Hereinafter, embodiments according to the invention are described in detail with reference to the drawings. It is to be noted that the following description shows embodiments of the invention, and this invention is not limited to the embodiments described below. This invention is not limited to those of arrangements, layouts, sizes, size ratios, etc. shown in the respective drawings.

### First Embodiment

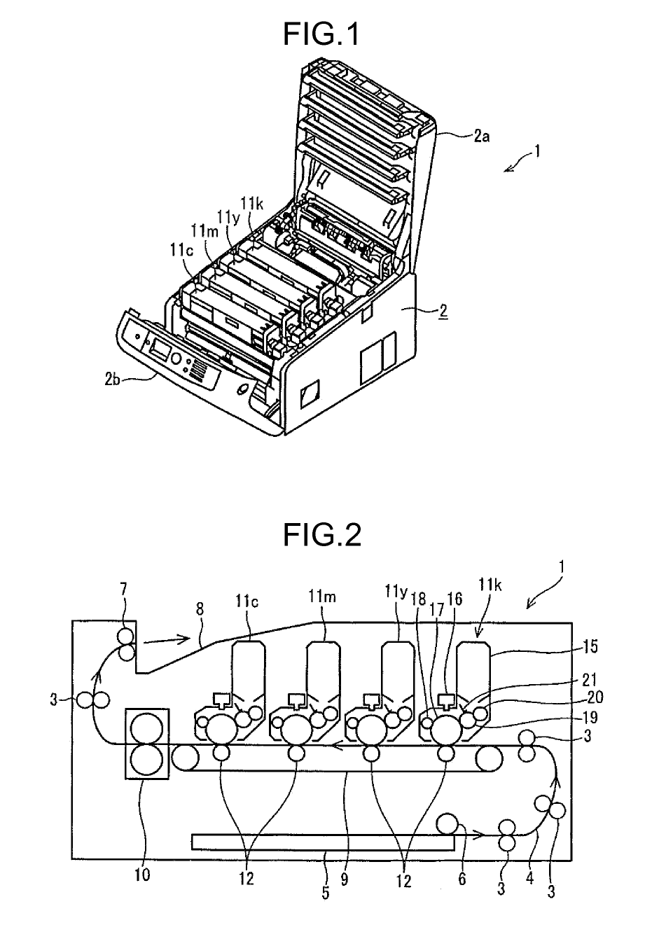

Referring to FIGS. 1 to 7, a printer and a developer unit according to this embodiment are described. The printer 1 as an image forming apparatus according to this embodiment is a printer of an electrophotographic method, and as shown in FIGS. 1, 2, a paper conveyance route 4 having such as plural conveyance rollers 3 is arranged in approximately a letter-S shape in an apparatus body 2 formed with an upper cover 2a and a front cover 2b, which are structured openably.

A paper cassette 6 containing paper as media for printing is disposed at a lower portion of the apparatus body 2. A feeding roller 6 is disposed at a connection point of one end of the paper conveyance route 4 for feeding the paper sheet by sheet to the paper conveyance route 4 from the paper cassette 5. A stacker 8 for stacking the printed paper delivered from delivery rollers 7 provided at the other end of the paper conveyance route 4 is arranged on a top surface of the upper cover 2a.

Along the paper conveyance route 4 in the conveyance direction of the paper (hereinafter called to as the paper conveyance direction), arranged are the plural conveyance rollers 3, a conveyance belt 9 conveying the fed paper upon attaching the paper with electrostatic effect, and a fixing unit 10 serving as a fixing means for fixing toner images as developer images with pressure and heat onto the paper. Plural developer units 11 as image forming units facing a top surface of the conveyance belt 9 over the conveyance route 4, and transfer rollers 12 as developer image transfer means disposed in facing the respective developer units 11 inside the conveyance belt 9 are arranged on an upstream side in the paper conveyance direction of the fixing unit 10.

The developer units 11 of this embodiment are detachably attached with respective toner cartridges 15 serving as developer containers containing respective toners as developers in respectively setting colors, or namely K color (black), Y color (yellow), M color (magenta), and C color (cyan). Those, four developer units 11k, 11y, 11m, 11c are disposed in a sequence to form toner images along the paper conveyance direction, and is structured as detachably attaching to the printer 1, respectively.

The developer unit 11 includes such as, e.g., in addition to the toner cartridge 15 described above, a photosensitive drum 17 serving as an image carrier for forming electrostatic latent images with an exposure head 16 as an exposure means, a charge roller 18 serving as a charge means for charging the photosensitive drum 17 uniformly, a developing roller 19 serving as a developer carrier for developing the electrostatic latent images on the photosensitive drum 17 in attaching the toner, a supply roller 20 serving as a developer supply means for supplying the toner to the developing roller 19, and a developing blade 21 serving as a developer layer limiting member for making the toner thickness on the surface of the developer roller 19 thin in a prescribed thickness.

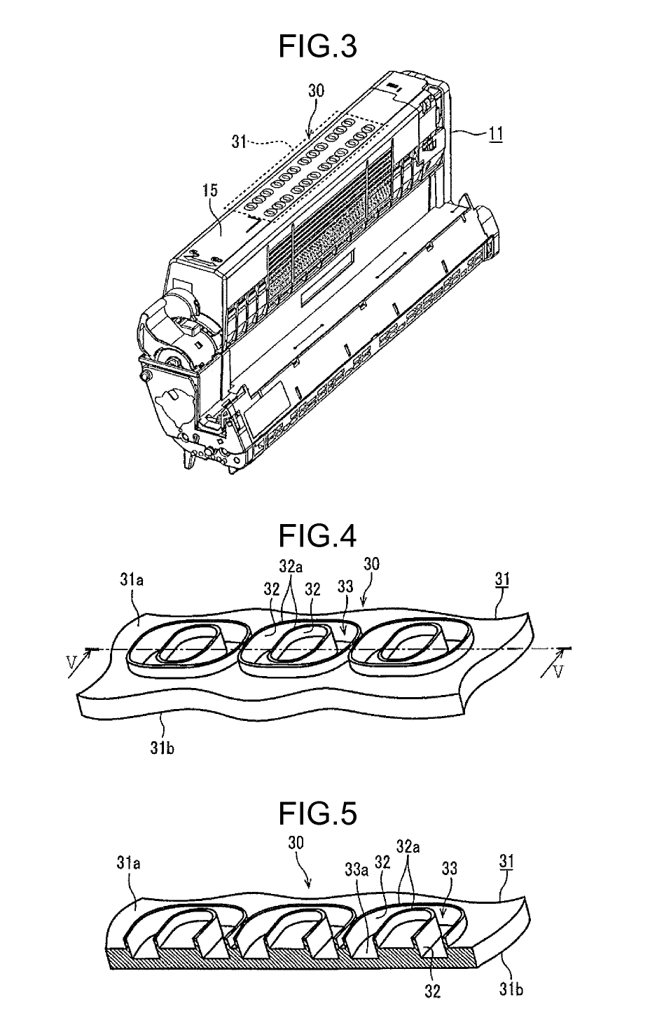

The developer unit 11 according to this embodiment is, as shown in FIG. 3, formed with an indication formation portion 31 for forming a logotype or logo 30 serving as an identification indication for identifying the maker as a source of manufacture, such as, e.g., name, abbreviation, code, number, and trademark of the maker manufacturing this developer unit 11 or the toner cartridge 15, on a top surface of the container body or housing of the toner cartridge 15. The indication formation portion 31 is made on an outer surface of a container body, or a body or housing of the toner cartridge 15, and is preferably made in a united body with the outer surface of the container body.

The logo 30 of this embodiment is structured with plural letters, or namely in this embodiment, three “O” as shown in FIGS. 4, 5. An outline portion 32 in a shape appeared as the letter itself is formed as a projecting portion projecting from a top surface 31a as an outer side surface of the indication formation portion 31, or namely as a projecting portion having a substantially rectangular cross section such that a top surface 32a of the outline portion 32 is projecting outwardly from the top surface 31a of the indication formation portion 31 (see, FIG. 5). In other words, the outline portion 32 is projecting outwardly from the top surface of the indication formation portion 31.

A content region 33 as a region surrounded by the outline portion 32 is formed as a recess having a substantially rectangular cross section grooved from the top surface 32a of the outline portion 32 toward a back surface 31b as an inner side surface of the indication formation portion 31, and preferably as shown in FIG. 5, a bottom surface 33a is located at a level grooved from the top surface 32a of the outline portion 32 toward the back surface 31b of the indication formation portion 31, or namely is formed at a position closer to the back surface 31b with respect to the top surface 31a of the indication formation portion 31. In other words, the content region 33 is formed as recessing inwardly from a top surface 32a of the outline portion.32. The logo 30 is uniformly molded through a molding method such as, e.g., an injection molding for resin materials when the container body of the toner cartridge 15 is manufactured. With this molding, the logo 30 according to this embodiment can stop occurrences of peeling in a case that a label is adhered.

As described above, in this embodiment, the logo 30 is formed with the outline portion 32 as the projecting portion and with the content region 33 as the recess surrounded by the outline portion 32, and therefore, the logo 30 can be easily recognized even where the logo 30 is worn out, cut off, or subject to defects such as cracking due to contacts among parts or contacts with other parts during transportation and use of, e.g., the developer unit 11 and the toner cartridge 15, and even where foreign objects such as dusts are attached or accumulated.

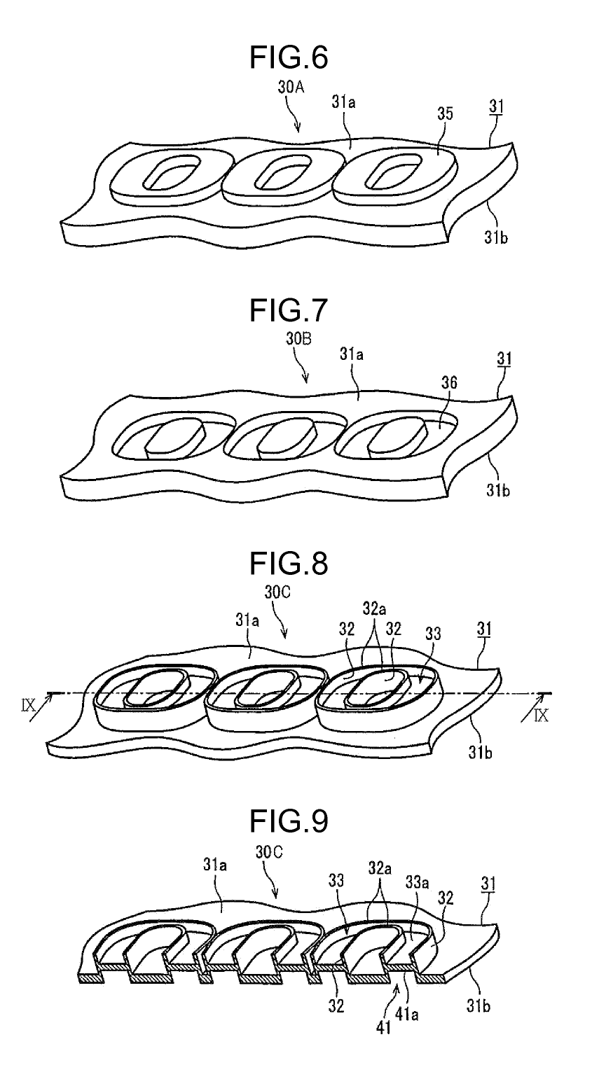

That is, as shown with a comparative example in FIG. 6, where a logo 30A is formed only from a projecting portion 35 projecting from the top surface 31a of the indication formation portion 31, the logo 30A may not be recognized if a part or all of the shape of the projecting portion 35 is lost. As shown with a comparative example in FIG. 7, where a logo 30B is formed only from a recess 36 grooved from the top surface 31a of the indication formation portion 31, the logo 30B may not be recognized if the recess 36 is filled where foreign objects are attached or accumulated to a part or all of the bottom of the recess 36.

To the contrary, the logo 30 according to the embodiment is formed with the outline portion 32 as the projecting portion projecting from the top surface 31a of the indication formation portion 31 and with the content region 33 as the recess portion surrounded by the outline portion 32 having the bottom surface 33a formed closer to a side of the back surface 31b with respect to the top surface 31a of the indication formation portion 31, so that the content region 33 formed as the recess portion maintains the shape of the logo 30 even where the outline portion 32 as the projecting portion is suffered from a loss or losses, and so that the logo 30 can be recognized easily. The outline portion 32 as the projecting portion also maintains the shape of the logo 30 even where the content region 33 as the recess portion is filled due to attachment or accumulation of foreign objects, so that the logo 30 can be recognized easily.

### Second Embodiment

Hereinafter, referring to FIGS. 8, 9, a logo according to this embodiment is described. It is to be noted that the same portions as those in the first embodiment are assigned with the same reference numbers, and the description for the portions is omitted for the sake of brevity. With the logo 30C according to the second embodiment, as shown in FIG. 8, FIG. 9, the outline portion 32 in a shape appeared as the letter itself is formed, in substantially the same way as that in the first embodiment, as a projecting portion having a substantially rectangular cross section projecting from the top surface 31a of the indication formation portion 31 (see, FIG. 9).

The content region 33 surrounded by the outline portion 32 is formed, in substantially the same way as that in the first embodiment, as a recess having a substantially rectangular cross section grooved from the top surface 32a of the outline portion 32 toward the back surface 31b of the indication formation portion 31. As shown in FIG. 9, the bottom surface 33a is formed at a position grooved from the top surface 32a of the outline portion 32 toward the back surface 31b of the indication formation portion 31 as well as at a position outer than the top surface 31a of the indication formation portion 31, or namely at a position closer to the top surface 32a of the outline portion 32.

A back surface content region 41 as a part of the back surface 31b of the indication formation portion 31 corresponding to the recessed bottom surface 33a of the content region 33 is formed as a recess portion having a substantially rectangular cross section grooved toward the top surface 31a of the indication formation portion 31, and preferably, a back surface 41a of a recess portion of the back surface content region 41 is formed at a position closer to the top surface 32a of the outline portion 32 with respect to the top surface 31a of the indication formation portion 31 and at a position opposing to the bottom surface 33a of the content region 33 over a prescribed thickness, or namely at a position between the top surface 31a of the indication formation portion 31 and the recessed bottom surface 33a of the content region 33. That is, the bottom surface 33a of the content region 33 has a back surface 41a recessing outwardly from the inner surface, or namely the back surface 31b, of the housing of the toner cartridge 15. The back surface 41a of the bottom surface 33a of the content region 33 is located at a position outer than the inner surface, or namely the back surface 31b, of the housing of the toner cartridge 15.

With this structure, in addition to substantially the same advantages brought from the first embodiment, the toner contained in the container may be leaked out if the outline portion 32 as the projecting portion or the bottom surface 33a of the recess portion of the content region 33 is worn out, cut off, or damaged with some loss due to, e.g., contacts and collisions among the parts during transportation of the logo 30C, so that failures of the parts such as toner cartridges 15 during transportation may be discovered easily, thereby making the quality of the shopped parts further stable.

In the above embodiments, the recess portions and the projecting portions of the logos 30, 30C are described as molded in a united body when the container body forming the logos 30, 30C is molded with a resin or resins, but when the container body such as, e.g., the toner cartridge is made of a metal material, the logos 30, 30C may be machined or pressed, or may be made from, e.g., cold forging.

With the above embodiments, the developer container is described as the toner cartridge 15, the developer container is not limited to the toner cartridge, but can be a developer container such as a toner bottle to supply toner to be filled in, e.g., the toner cartridge 15. In such a case, the logos 30, 30C may be formed at the indication formation portion 31 arranged at a side surface or shoulder of the bottle.

In the above embodiments, the image forming apparatus is described as the printer of the electrophotographic method, but the image forming apparatus is not limited to the above apparatus, but is applicable to any apparatus as far as it is such as printer, facsimile machine, and photocopier forming monochrome or multicolor images on media such as, e.g, printing papers, envelopes, OHP sheets, and roll papers in use of the electrophotographic method.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A developer container having an indication formation portion for forming an identification indication, the developer container comprising:
an outline portion outlining a shape of the identification indication, the outline portion being formed projecting from a top surface of the indication formation portion; and
a content region surrounded by the outline portion, the content region being formed recessing from a top of the outline portion toward a back side of the indication formation portion.

2. The developer container according to claim 1, wherein the content region has a bottom lower than the top surface of the indication formation portion.

3. The developer container according to claim 1, wherein the bottom of the content region has a back side recessing upwardly from a back surface of the indication formation portion.

4. The developer container according to claim 3, wherein the back side of the bottom of the content region is located at a position upper than the top surface of the indication formation portion.

5. An image forming unit having the developer container according to claim 1.

6. An image forming apparatus having the image forming unit according to claim 5.

7. A developer container comprising:
a container body for containing a developer; and
an indication formation portion formed on an outer surface of the container body for forming an identification indication the indication formation portion comprising an outline portion outlining a shape of the identification indication, and a content region surrounded by the outline portion, the content region being formed recessing inwardly from a top of the outline portion.

8. The developer container according to claim 7, wherein the outline portion is formed projecting from the outer surface of the container body.

9. The developer container according to claim 7, wherein the content region has a bottom lower than the outer surface of the container body.

10. The developer container according to claim 7, wherein the bottom of the content region has a back surface recessing outwardly from an inner surface of the container body.

11. The developer container according to claim 11, wherein the back surface of the bottom of the content region is located at a position outer than the inner surface of the container body.

12. The developer container according to claim 7, wherein the container body is a toner cartridge, and wherein the identification indication includes information for identifying a source of manufacture.

13. The developer container according to claim 7, wherein the indication formation portion is formed from an injection molding method together with the container body.

14. An image forming unit having the developer container according to claim 7.

15. An image forming apparatus having the image forming unit according to claim 14.

16. The developer container according to claim 1, wherein the back surface contacts with a developer to be contained.

17. The developer container according to claim 10, wherein the back surface contacts with a developer to be contained.
